(19) United States
(12) Patent Application Publication
(10) Pub. No.: US 2005/0049950 A1
(43) Pub. Date: Mar. 3, 2005

(54) Method for depositing funds to a stored value card

(75) Inventor: Timothy P. Johnson, Columbus, GA (US)

Correspondence Address: TIM HEADLEY, GARDERE WYNNE SEWELL LLP, 1000 LOUISIANA, SUITE 3400, HOUSTON, TX, 77002, US

(73) Assignee: Allcard Financial Services, Inc., Houston, TX (US)

(21) Appl. No.: 10/927,886

(22) Filed: Aug. 27, 2004

Related U.S. Application Data
(60) Provisional application No. 60/499,864, filed on Sep. 3, 2003.
(60) Provisional application No. 60/500,873, filed on Sep. 5, 2003.
(60) Provisional application No. 60/503,350, filed on Sep. 16, 2003.

(51) Int. Cl. G06F 17/60

(52) U.S. Cl. 705/35

(57) ABSTRACT

A method for depositing funds to an SVC, issued by an issuer such as a bank, or through an approved agent of the bank. The method enables the SVC cardholders to deposit funds into the account individually or via direct deposit from an employer. Deposits are made at any bank or any ATM, and the funds deposited are available for use by the SVC cardholder.

### CROSS-REFERENCES TO RELATED APPLICATIONS

This application claims the benefit of:
U.S. Provisional Patent Application No. 60/499,864, filed Sep. 3, 2003,
U.S. Provisional Patent Application No. 60/500,873, filed Sep. 5, 2003, and
U.S. Provisional Patent Application No. 60/503,350, filed Sep. 16, 2003.

### FIELD OF THE INVENTION

This invention relates to depositing funds to stored value cards.

### BACKGROUND OF THE INVENTION

The existing methods for depositing funds to bank accounts are well known. An individual may make a deposit by presenting a deposit slip to a teller at a bank, while a business may make a deposit electronically by using the Federal Reserve Bank's Automated Clearinghouse (ACH) mechanism. The first method, individual deposit, allows an individual to deposit funds to his personal accounts. The second method allows a business to pay bills, as well as to pay employees electronically using ACH, commonly known as direct deposit. These two means of depositing money traditionally apply to standard bank accounts such as checking and savings accounts, which are owned by an individual or business.

More recently, bank accounts are accompanied by debit/ATM cards and associated Personal Identification Numbers (PINs). When used by the accountholder, the debit card allows the accountholder to present the debit card at any place accepting such cards and render payment directly from the accountholder's bank account. The debit/ATM card also enables the accountholder to withdraw a specified amount from the accountholder's bank account at Automated Teller Machines (ATMs) or other terminals at the accountholder's convenience. Additionally, one can use an ATM card to make deposits into the associated bank account. However, the debit/ATM cards are available only to those individuals or businesses which meet the identification and minimum requirements to open a bank account.

For those unable to open individual bank accounts, options are limited—they may either cash their entire paychecks, incurring large check cashing fees, or they can use a relatively unknown product, a stored value card (SVC). Stored value cards differ from credit cards in that they have no line of credit, and differ from debit cards in that they are not typically linked to the SVC cardholder's existing deposit account at a bank. Stored value cards are pre-loaded with funds, and can be used for making purchases or withdrawing cash up to the value that has been associated with the card.

Currently, there are four methods used to fund an SVC: direct deposit through an employer utilizing ACH, loading value at a retailer via a terminal or other system, wire transfer, and account-to-account transfer. For the sake of this background information, only the first two methods will be discussed in detail.

The first method involves establishing direct deposit through an employer, who utilizes the ACH mechanism to regularly add value to the SVC. A card processing center informs the employer, either directly or through the bank, of the SVC cardholder's deposit information, including the routing & transit number and the account number associated with the SVC. The routing & transit number is supplied to the issuing bank from the Federal Reserve, and is typically the same for all SVCs issued by the issuer. The account number is unique for the individual SVC account, but is not unique for each individual SVC cardholder. The employer includes the deposit routing information in the accounts payable or payroll systems such that when these systems execute, a record is added to the ACH file. The ACH file is sent to the Federal Reserve that identifies from which account to withdraw funds (e.g. employer payroll account at Bank A), and to which account to deposit funds (e.g. employee SVC account at Issuing Bank B). The SVC account is now funded, and the SVC cardholder is able to use the card as defined by the issuer to buy goods and services, and withdraw cash up to the balance associated with the card. The employer can repeat the funding process periodically, thus increasing the SVC account balance with each deposit.

There are many different kinds of SVCs, including smart cards (i.e. chip cards), closed-loop merchant gift cards, PIN-only cards, and Association branded cards. The Association branded card is a Visa® or MasterCard® that is issued by an issuing bank to an individual. There are three ways that an individual can attain an Association branded card: by enrolling through a bank, enrolling through the individual's employer, or by purchasing an SVC from a retail outlet.

To receive a stored-value card through a bank, an individual must first complete an enrollment form. The bank then establishes the account and mails the card to the individual, who must activate the card by phone. The bank informs the employer of the individual's routing information, and the employer enters the routing data into its payroll system. When payroll is run, the individual is paid via direct deposit.

To receive a stored-value card through an employer, the individual must first complete an enrollment form. The employer then supplies the bank with the employee's data, the bank establishes the account, and the card is mailed to the employer, or directly to the employee. If mailed to the employer, the employer distributes the card to the individual, who must activate the card by phone. The bank informs the employer of the individual's routing information and the employer enters the routing data into the payroll system. When payroll is run, the individual is paid via direct deposit.

Under the present system, SVCs issued through this method have many shortcomings. Though all current SVC systems have the capability to identify a specific card and its unique “available” value, all SVCs associated with an issuing bank draw from a single pool of funds, and no individual SVC cardholder can directly access his individual account. As the issuing bank often views the SVC cardholder as a credit risk, it asserts a greater degree of control over the SVC by working only through the employer or store-front retailer to prevent the SVC cardholder from accessing the overall SVC fund pool.

Further, the SVC cardholder is restricted as to how funds are loaded onto the card. SVC cardholders do not have the ability to deposit funds at the bank, and typically, the bank accepts deposits only via the employer's direct deposit or through a store-front retailer. If the SVC cardholder is not employed, there is no way to fund the card. If the SVC cardholder does not enroll in direct deposit, or if the employer does not offer direct deposit, the SVC cardholder cannot receive funding for the SVC account. Therefore, the SVC cardholder is typically unable to add non-payroll funds to the SVC account. Additionally, if the SVC cardholder has multiple employers or places of employment, the SVC cardholder does not have the ability to supply additional employers with the information necessary to deposit those additional funds into the SVC cardholder's SVC account. Moreover, these cards are typically associated with the employer. When the SVC cardholder changes jobs, the original employer cancels funding, forcing the SVC cardholder to dispose of the card once the funds are depleted. Finally, it is currently not possible for anyone other than the SVC cardholder's employer to deposit funds to the SVC account, because the necessary routing information is not available to anyone other than the SVC cardholder's employer.

The second method of acquiring and funding an SVC is via a retailer. There are at least two ways to receive an SVC from a retail outlet. However, each method requires an individual to purchase the card, supply the retailer with personal data, and give the retailer cash or a cash equivalent to deposit to the card. This is typically accomplished by the SVC cardholder presenting the retailer with cash or a check and having the retailer deposit the funds to the card using a specially designed Point-Of-Sale (POS) terminal and software. This can be done in real-time or in batches.

SVCs issued through this method have two major shortcomings. First, each time that the SVC cardholder wishes to deposit funds to the stored-value card account, he must return to a store-front of the retailer that sold the card, or to another retailer that is approved for re-funding, and is equipped to handle such a transaction. Second, the SVC cardholder must pay a substantial fee each time the funding takes place.

It would therefore be advantageous to have a method for depositing funds to SVCs that addresses the shortcomings of the current depository methods described above. It would be advantageous to provide the SVC cardholder, and others, the ability to deposit funds to the SVC cardholder's SVC account at a bank or ATMs, as opposed to requiring the SVC cardholder to return to a store-front retailer or other approved agent to add value to the SVC account. This would allow the SVC cardholder the ability to deposit funds other than an employer's payroll check (for instance, payroll from a second [or third, etc.] job, cash, money orders, etc.) into the SVC cardholder's SVC account. It would also be advantageous to allow the SVC cardholder to retain control over the SVC Account, regardless of the SVC cardholder's employment status. Additionally, it would also be desirable to allow other persons, such as the SVC cardholder's family members, to deposit funds into the SVC cardholder's SVC account.

### SUMMARY OF THE INVENTION

The present invention is a method for depositing funds to an SVC account that allows the consumer more flexibility in managing his financial affairs. Utilizing the method of the present invention, a card issuer, such as a bank or its agent, issues a card and offers it to the individual either directly or through an employer. Once the individual completes an application for an account, information is sent to a card processing center which manages the SVC account, including all relevant data such as the SVC cardholder name and address, card number, routing and transit number, internal account number, and the account balance. Upon creation of the individual SVC cardholder's account, the issuer issues a card, and the SVC cardholder activates the card via telephone, mail, fax, in-person at the issuing bank or to the agent, or online. Deposits can then be made to the account.

In the method of the present invention, a processing center acts on behalf of the bank, performing all data processing functions related to the SVC cardholder and the cardholder's account. The issuing bank provides the processing center with its own account number for the pool of SVC funds, and the processing center creates its own internal account numbers to distinguish among the different SVC cardholder accounts. At every step of the process, including purchases, the processing center is able to validate the SVC cardholder's account to determine that the SVC cardholder is in good standing, and that the SVC cardholder's “available” balance will cover authorization requests.

In another feature of the method of the present invention, should an SVC cardholder elect to fund the SVC account through direct deposit from his employer, the employer is informed of the SVC cardholder's deposit information, either directly by the SVC cardholder or through the issuing bank. The employer receives the issuing bank's Routing & Transit (R/T) number and the processing center's internal account number for the SVC cardholder's Deposit Account. The employer includes the deposit routing information in the accounts payable or payroll systems such that when these systems execute, a record is added to the ACH file. The ACH file is sent to the Federal Reserve, which identifies the account from which funds are to be withdrawn (i.e. employer payroll account at Bank A), and the account to which funds are to be deposited (i.e. employee SVC account at Issuing Bank B). The funds are then deposited to the appropriate SVC account using the R/T number and then, using the internal account number, applied to the SVC cardholder's individual account. The SVC cardholder is now able to use the card to buy goods and services and withdraw cash up to the balance associated with the SVC. The employer may repeat the funding process periodically, and the SVC balance will be updated accordingly.

The invention further contemplates utilizing any of several methods to allow the SVC cardholder the capability of self-depositing funds to his SVC account. Unlike current methods which require the card to be funded either through an employer's direct deposit or at a retailer equipped to reload value to the SVC, the method of the present invention allows the SVC cardholder to deposit several types of funds (check, cash, money order, etc.) to the SVC cardholder's Deposit Account at any bank or ATM terminal, regardless of association with the issuing bank. The SVC cardholder is able to walk into a bank and present the teller with the funds to be deposited, the R/T number of the issuing bank, and the account number. The bank then accepts the funds as a deposit into the SVC account. The SVC cardholder may also utilize ATMs to make deposits.

The method of the present invention generates revenue by increasing deposit volume and card spending, thus increasing revenue from float-on deposits, and by charging fees for deposits at non-issuing bank branches and ATMs.

The method of the present invention has many advantages over the prior art methods for depositing funds to SVC accounts. First, the SVC cardholder no longer must rely solely on employer direct deposit, or return to the place of purchase to load and re-load funds to the card. The method of the present invention enables the SVC cardholder to present any check to any bank, cash the check, deposit a portion of the check into the SVC account, and receive cash back for the remainder of the funds. The SVC cardholder may also present cash or any other form of legal tender to any bank, and accomplish the same objectives. All of these functions may take place at any branch of the issuing bank, ATM of the issuing bank, or even at a non-issuing bank or ATM. Second, the method of the present invention allows persons other than the SVC cardholder, such as the SVC cardholder's family members, to deposit funds into the SVC cardholder's SVC account in the same modes identified above for the SVC cardholder. Third, the SVC cardholder, or anyone else, can receive cash back at the issuing bank by presenting a check as part of the deposit and receiving cash back as a result. Fourth, the invention does not require that the card be disposed of when an individual changes employers, but rather allows the SVC cardholder to keep the SVC account open, and deposit his own funds to the account. Thus, the SVC cardholder's employer no longer retains control over the card, and the account associated with the card need not be closed when employment ends.

Another advantage of the present invention is that it gives the issuing bank the ability to down-sell an SVC to a potential customer who does not qualify for a checking account. Another advantage of the present invention is that it can be used for card Associations including, but not limited to, American Express and Discover.

### BRIEF DESCRIPTION OF THE DRAWINGS

Further objects, features and advantages of the invention will become apparent from the following detailed description, taken in conjunction with the accompanying figures showing illustrative embodiments of the present invention.

FIG. 1 illustrates the components of a system for depositing funds to an SVC account in accordance with the invention.

FIG. 2 is a flowchart that illustrates a process for depositing funds in-person at a bank or ATM in accordance with the invention.

FIG. 3 illustrates a process for depositing funds into an SVC account via direct deposit by an employer.

Throughout the figures, unless otherwise stated, the same reference numerals and characters are used to denote like features, elements, components, or portions of the illustrated embodiments. Moreover, while the subject invention will now be described in detail with reference to the figures and in connection with the illustrative embodiments, changes and modifications can be made to the described embodiments without departing from the scope and spirit of the present invention, as defined by the appended claims.

### DETAILED DESCRIPTION OF THE INVENTION

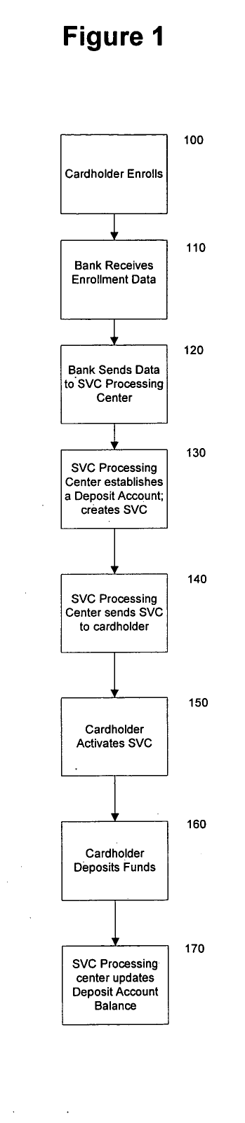

FIG. 1 illustrates the process for depositing funds into the account associated with the Stored Value Card (SVC). The process begins with the SVC cardholder's enrollment. In step 100; the SVC cardholder may enroll through an employer or via a participating bank or its authorized agent. After enrollment in the SVC program, in step 110 the SVC cardholder's enrollment data is received by the issuing bank. In step 120 the bank sends the SVC cardholder's data to the SVC processing center The data may include the SVC cardholder's name and address, the card number, routing and transit number, internal account number, and the account balance. The issuing bank has already established a funds “pool” account for receipt of all electronic deposits. The processing center receives notification of the total value deposited in the pool account and then the processing center internally parses its deposit information into individual SVC cardholder accounts. However, all funds are deposited into the funds pool account at the issuing bank. In step 130 the processing center creates a new internal Deposit Account specific to that SVC cardholder and creates an SVC associated with the Deposit Account. In step 140 the processing center sends the SVC to the SVC cardholder via mail or other mode of physical delivery. In step 150 the SVC cardholder activates, via phone, fax, mail, in person at the bank, or the internet, the SVC, and the cardholder receives the personal identification number (PIN) associated with the SVC. Once the SVC cardholder activates the SVC, in step 160 the SVC cardholder may make deposits into the Deposit Account either in-person at any bank or ATM terminal, or via direct deposit from an employer. After a deposit is made into the SVC cardholder's account, in step 170 the bank updates its SVC account, and the SVC processing center updates its internal Deposit Account to reflect the SVC cardholder's new balance. The “bank” at which funds are deposited into the SVC cardholder's account may include the issuing bank or any of its branches, the issuing bank's ATM terminals, any approved correspondent bank, any approved agent of the issuing bank, or any non-issuing bank and ATMs.

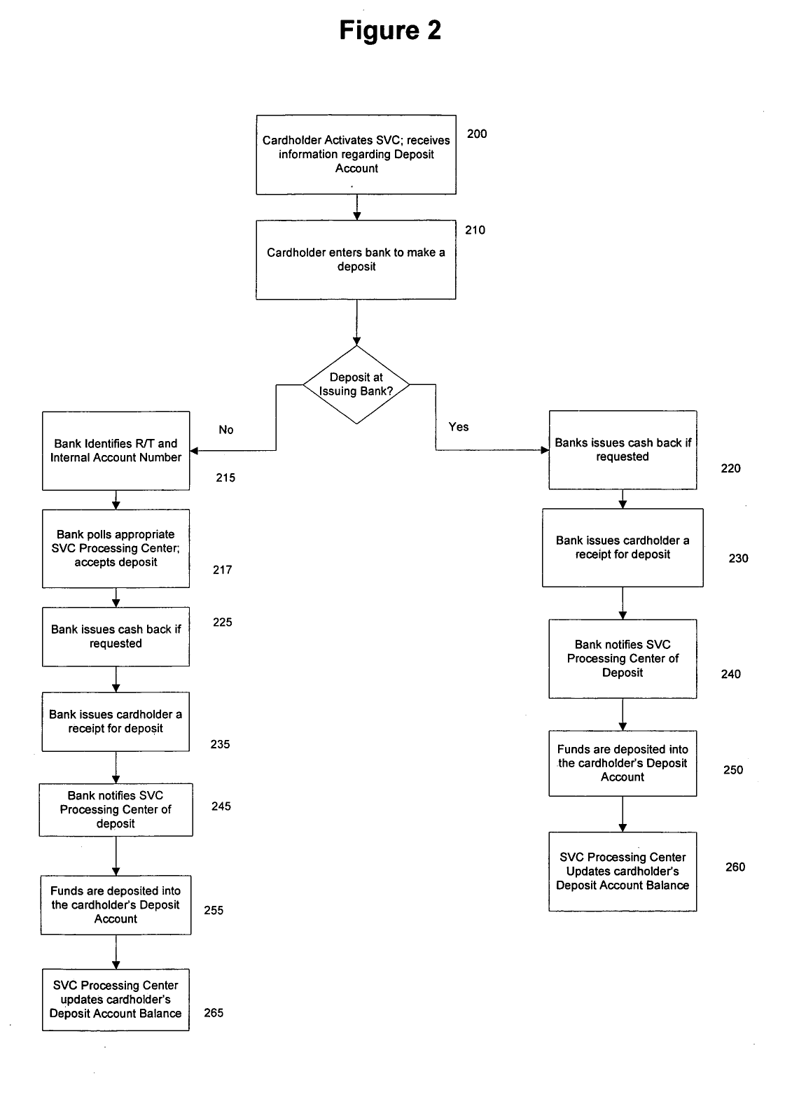

FIG. 2 illustrates the process by which funds are deposited into the SVC cardholder's Deposit Account in-person by the SVC cardholder or another person. In step 200, after the SVC cardholder receives the SVC, pre-printed deposit slips, and account information, the SVC cardholder activates the card. The card may be activated over the phone, by mail, fax, in person at the bank, or over the Internet. Once the card is activated, the Deposit Account is ready for funds to be deposited in a variety of methods. The deposit slip contains the information needed to deposit funds directly into the Deposit Account associated with the SVC. The SVC cardholder may also download a deposit slip containing the same information as the pre-printed deposit slip via the Internet, or place an order for additional pre-printed deposit slips online, via telephone, or in person, at any branch of the bank.

In step 210, the SVC cardholder enters any bank to make a deposit, presenting the funds to be deposited and a means of identifying the SVC cardholder's Deposit Account. Additionally, using the SVC and PIN number associated with the card, the SVC cardholder may make deposits at ATMs. If the SVC cardholder presents at an issuing bank or ATM, in step 220, the issuing bank will distribute the requested cash back, if any, and in step 230, the SVC cardholder receives a receipt acknowledging the deposit. The issuing bank notifies the SVC processing center that a deposit has been received, and updates the processing center's account in step 240. The funds are deposited into the processing center's account in step 250, and in step 260, the SVC processing center updates the SVC cardholder's Deposit Account to reflect the deposit.

If in step 220 the deposit is presented at a non-issuing bank or ATM, then in step 215, the non-issuing bank identifies the R/T and internal account number as that of an SVC that is issued by another bank. In step 217, the appropriate SVC processing center is polled to verify the account, and upon receipt of confirmation, the deposit is accepted by the non-issuing bank. In step 225, after the Bank accepts the deposit, it gives cash back if requested. In step 235, the Bank gives the SVC cardholder a receipt acknowledging the deposit. In step 245, the non-issuing bank notifies the SVC processing center via the Federal Reserve of the deposit to the SVC cardholder's account. In step 255, the funds are deposited into the SVC cardholder's account. In step 275, the SVC processing center updates the SVC cardholder's Deposit Account to reflect the new balance.

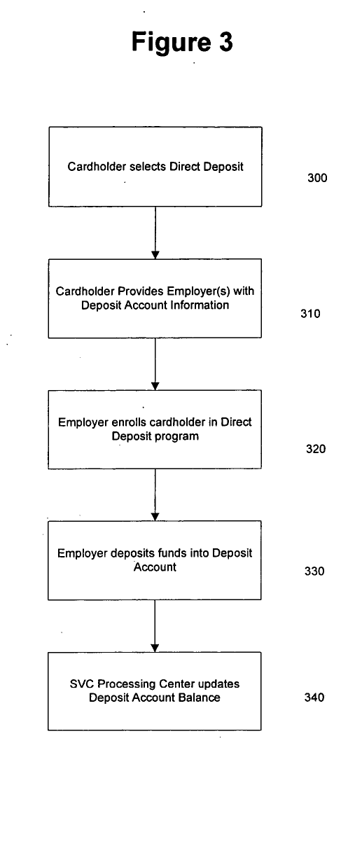

FIG. 3 illustrates the means by which the SVC cardholder's employer or employers may deposit funds into the SVC cardholder's account via direct deposit. In step 300, upon activation of the SVC, the SVC cardholder selects direct deposit with the SVC cardholder's employer or employers. In step 310, the SVC cardholder provides each employer with a voided deposit slip or the SVC cardholder's account information. In step 320, the employers then enroll the SVC cardholder in their respective direct deposit programs using the SVC Deposit Account information. In step 330, the employer periodically deposits funds into the SVC cardholder's account. In step 340, the SVC processing center updates the SVC cardholder's Deposit Account to reflect the new balance.

1. A method for an SVC processing center to enable a person to deposit and spend money, using an SVC, the method comprising the following steps:
a. opening an account at a bank;
b. providing opportunities and helpful instructions to the person so that the person can supply correct application data for enrolling in the SVC processing center's SVC program;
c. receiving the person's application data, and establishing an SVC account for the person;
d. issuing an SVC to the person either directly or through the person's employer;
e. activating the person's SVC; and
f. updating the person's SVC account whenever the person, using his SVC, makes deposits and withdrawals at the bank.

2. The method of claim 1, wherein the step of activating is done in response to a person's request that is made by any one of the group of: by telephone, by mail, by fax, online, or in-person.

3. The method of claim 2, wherein the application data in the step of receiving includes all relevant data such as the person's name and address.

4. The method of claim 3 wherein in the step of issuing an SVC, the SVC processing center acts on behalf of the bank to issue an SVC to the person, on the previously established SVC processing center's account at the bank.

5. The method of claim 4, wherein the SVC processing center establishes its own internal account numbers for each person.

6. The method of claim 5 wherein the SVC processing center's account number for the person includes the issuing bank's routing and transit number.

7. The method of claim 6 wherein the person has a personal identification number (PIN) associated with the SVC.

8. The method of claim 7 wherein the person is provided pre-printed deposit slips containing the person's name and address, card number, processing center account number, and issuing bank routing and transit number.

9. The method of claim 8 wherein the person may make deposits into the person's SVC account at any bank or ATM, regardless of whether the bank or ATM is associated with the issuing bank.

10. The method of claim 9 wherein the person's employer is allowed to deposit funds via ACH into the person's SVC account.

11. The method of claim 10 wherein more than one employer is allowed to deposit funds via ACH into the person's SVC account.

12. The method of claim 11 wherein anyone other than the person is allowed to deposit funds into the person's SVC account.

13. The method of claim 12 wherein the person is allowed to receive cash back when the person deposits money into the person's SVC account.

14. The method of claim 13 wherein the SVC processing center issues a receipt to the person acknowledging a deposit into the person's SVC account.

15. The method of claim 14 wherein the employer cannot access the SVC cardholder's Deposit Account balance other than to deposit funds.

16. The method of claim 15 wherein the SVC processing center allows the person to retain the SVC card and associated SVC account even after leaving the employ of a depositing employer.

17. The method of claim 16 wherein the SVC processing center charges fees to other SVC companies to enable multiple methods of deposits to their cards.

18. A method for a bank to enable a person to deposit and spend money, using an SVC, the method comprising the following steps:
a. assisting the person to open an SVC account at the bank;
b. providing information about the person to an SVC processing center;
c. establishing an SVC account for the person at an SVC processing center;
d. issuing an SVC to the person either directly or through the person's employer;
e. activating the person's SVC; and
f. updating the person's SVC account whenever the person, using his SVC, makes deposits and withdrawals at the bank.

19. The method of claim 18, wherein the step of activating is done in response to a person's request that is made by any one of the group of: by telephone, by mail, by fax, online, or in-person.

20. The method of claim 19, wherein the information includes all relevant data such as the person's name and address.

21. The method of claim 20 wherein in the step of issuing an SVC, the SVC processing center acts on behalf of the bank to issue an SVC to the person, on a previously established SVC processing center's account at the bank.

22. The method of claim 21, wherein the SVC processing center establishes its own internal account numbers for each person.

23. The method of claim 22 wherein the SVC processing center's account number for the person includes the bank's routing and transit number.

24. The method of claim 23 wherein the person has a personal identification number (PIN) associated with the SVC.

25. The method of claim 24 wherein the person is provided pre-printed deposit slips containing the person's name and address, card number, processing center account number, and issuing bank routing and transit number.

26. The method of claim 25 wherein the person may make deposits into the person's SVC account at any bank or ATM, regardless of whether the bank or ATM is associated with the issuing bank.

27. The method of claim 26 wherein the person's employer is allowed to deposit funds via ACH into the person's SVC account.

28. The method of claim 27 wherein more than one employer is allowed to deposit funds via ACH into the person's SVC account.

29. The method of claim 28 wherein anyone other than the person is allowed to deposit funds into the person's SVC account.

30. The method of claim 29 wherein the person is allowed to receive cash back when the person deposits money into the person's SVC account.

31. The method of claim 30 wherein the SVC processing center issues a receipt to the person acknowledging a deposit into the person's SVC account.

32. The method of claim 31 wherein the employer cannot access the SVC cardholder's Deposit Account balance other than to deposit funds.

33. The method of claim 32 wherein the SVC processing center allows the person to retain the SVC card and associated SVC account even after leaving the employ of a depositing employer.

34. The method of claim 33 wherein the SVC processing center charges fees to other SVC companies to enable multiple methods of deposits to their cards.
